(19) United States
(12) Patent Application Publication
(10) Pub. No.: US 2015/0002087 A1
(43) Pub. Date: Jan. 1, 2015

(54) INDUCTION CHARGING DEVICE

(71) Applicant: Juergen MACK, Goeppingen (DE)

(72) Inventor: Juergen MACK, Goeppingen (DE)

(73) Assignee: Robert Bosch GmbH, Stuttgart (DE)

(21) Appl. No.: 14/318,312

(22) Filed: Jun. 27, 2014

(30) Foreign Application Priority Data
Jun. 28, 2013 (DE) 10 2013 212 611.5

(51) Int. Cl. H02J 7/02

(52) U.S. Cl. CPC H02J 7/025
USPC 320/108; 320/145

(57) ABSTRACT

An induction charging device has: at least one charging electronics unit which includes at least one frequency unit situated between at least two DC voltage paths; at least one charging coil connected to a voltage tap of the at least one frequency unit; and at least one control unit provided to operate the at least one frequency unit at one frequency in at least one first operating state. The at least one control unit controls a power output via a pulse width modulation of a pulse duration of the first operating state relative to an operating period.

### BACKGROUND OF THE INVENTION

1. Field of the Invention

The present invention relates to an induction charging device.

2. Description of the Related Art

An induction charging device has already been provided having at least one charging electronics unit, which includes at least one frequency unit situated between at least two DC current paths, at least one charging coil connected to a voltage tap of the at least one frequency unit and at least one control unit and/or regulating unit, which is provided for operating the at least one frequency unit at one frequency in at least one first operating state.

### BRIEF SUMMARY OF THE INVENTION

The present invention is directed to an induction charging device, in particular, a primary induction charging device, having at least one charging electronics unit, which includes at least one frequency unit situated between at least two DC current paths, at least one charging coil connected to a voltage tap of the at least one frequency unit and at least one control unit and/or regulating unit, which is provided for operating the at least one frequency unit at one frequency in at least one operating state.

According to the present invention, it is provided that the at least one control unit and/or regulating unit is provided for controlling and/or regulating a power output via a pulse width modulation of a pulse duration of the first operating state relative to an operating period. This means, in particular, that in terms of the pulse width modulation, the entire first operating state is understood to mean a pulse. In particular, a ratio of the first operating state to the operating period is controlled and/or regulated via the pulse width modulation. Preferably, the at least one control unit and/or regulating unit is provided for controlling and/or regulating a power output via a superimposed pulse width modulation. Preferably, the induction charging device is formed from a hand-held tool induction charging device. In addition, the control unit and/or regulating unit is preferably provided for operating the frequency unit with at a resonance frequency, in particular a resonance frequency of an oscillating circuit of the charging coil. The control unit and/or regulating may in principle be formed from at least two sub-units separate from one another, of which at least one sub-unit is provided for operating at one frequency the at least one frequency unit in at least one first operating state, and of which a second sub-unit is provided for controlling and/or regulating a power output via a pulse width modulation of a pulse duration of the first operating state relative to an operating period. In this context, an “induction charging device” is intended to mean, in particular, a device for the inductive charging of induction rechargeable battery devices. Preferably, the device includes at least one control unit and/or regulating unit, which is provided for controlling and/or regulating a charging operation. In addition, a “hand-held tool induction charging device” in this context is intended to mean, in particular, an induction charging device for a hand-held power tool. In this case, a “hand-held power tool” is intended to mean, in particular, a power tool for machining workpieces, advantageously, however, a power drill, a drill hammer and/or percussion hammer, a saw, a screwdriver, a milling tool, a grinder, an angle grinder, a garden tool, a multi-functional tool and/or a measuring device.

A “primary induction charging device” in this context is intended to mean, in particular, an induction charging device which represents a primary side of the charging system during a charging operation. Preferably, it is understood to mean an induction charging device which is provided for converting electrical energy into a magnetic field which may, in particular, be converted from a secondary side back into electrical energy. In addition, a “charging electronics unit” in this context is intended to mean, in particular, an electronics unit which is provided for influencing at least one charging parameter such as, in particular, a charge voltage and/or a charge current. In this case, an “electronics unit” is intended to mean, in particular, a unit which influences at least one electrical current in a gas, in a conductor, in a vacuum and/or advantageously in a semiconductor. Preferably, the electronics unit includes at least one electronic component. Various electronic components are conceivable which appear useful to those skilled in the art, such as a capacitor, a resistance, a coil and/or a diode.

A “DC current path” in this context is intended to mean a part, preferably a path, of a circuit in which a current with an invariable sign flows. A “frequency unit” in this context is intended to mean, in particular, an electrical unit which generates an oscillating electrical signal, preferably at one frequency, in particular at a variable frequency, of at least 1 kHz, preferably of at least 10 kHz and particularly preferably of at least 20 kHz for an oscillating circuit and/or in particular for the charging coil. The frequency unit includes, in particular, at least one inverter which includes, in particular, at least two, bidirectional unipolar switches preferably connected in series, which are formed by a transistor and a diode connected in parallel. The inverter particularly preferably also includes in each case at least one damping capacitance connected in parallel to the bidirectional, unipolar switches, which is formed from at least one capacitor. In this way, a high frequency power supply of the oscillating circuit and/or in particular of the charging coil may be provided. A voltage tap of the frequency unit is situated, in particular, at a shared contact point of two bidirectional unipolar switches.

In addition, a “charging coil” in this context is intended to mean in particular an element which is made up at least partially of an electrical conductor, in particular a wound electrical conductor, which is situated at least partially in the form of a circular disk. Preferably, a voltage is induced in the electrical conductor in the presence of a magnetic field. A “control unit and/or regulating unit” is intended to mean a unit which includes at least control electronics. “Control electronics” is intended to mean, in particular, a unit including a processor unit and including a memory unit and including an operating program stored in the memory unit. Furthermore, “provided” in this context is intended to mean, in particular, specifically programmed, designed and/or equipped. An object provided for a particular function is intended to mean, in particular, that the object fulfills and/or carries out this particular function in at least one application state and/or operating state. In addition, a “power output” in this context is intended to mean, in particular, an output of energy of the induction charging device to a rechargeable battery and/or to a surroundings over time. Furthermore, “pulse duration” in this context is intended to mean, in particular, the duration of a pulse, in particular a current pulse and/or voltage pulse. An “operating period” in this context is intended to mean, in particular, a minimum interval after which an operating state, in particular a first operating state, or a sequence of operating states, such as, in particular, a first operating state and a second operating state, is repeated in full.

An advantageously high level of efficiency may be achieved with the embodiment of the induction charging device according to the present invention. In addition, it is possible with this embodiment to adjust a control and/or regulation of a power output in a particularly simple and cost-efficient manner. With the pulse width modulation an advantageously high dynamic during an activation may also be achieved. A high load-dependent stability, in particular, may also be achieved as a result. In addition, a number of components may, as a result, also be held to a minimum. In particular, no additional components are required in order, for example, to directly control and/or regulate a voltage. In this way, it is possible, in particular, to save costs and installation space for additional components. As a result of the embodiment according to the present invention, a, in particular, constant intermediate circuit voltage may be present in the DC current paths. A modulation of the voltage upstream from the frequency unit may thereby be dispensed with.

It is further provided that the at least one control unit and/or regulating unit is provided to control and/or regulate a power output via a pulse width modulation of a pulse duration of the first operating state relative to a constant operating period. A “constant operating period” in this context is intended to mean, in particular, an operating period having a constant period duration. In this way, it is possible to achieve an advantageously high level of efficiency. In particular, a control and/or regulation of a power output may be regulated in a particularly simple and cost-efficient manner. With the constant operating period it is possible, in particular, to implement an advantageously simple design capability.

In addition, it is provided that a voltage in the DC current paths is constant. In this way, an advantageous control and/or regulation in particular may be achieved.

It is further provided that the operating period includes the pulse-forming first operating state and one second operating state formed from a zero-voltage operating state. This means, in particular, that the device operates in two at least partially ideal states, a state in which the charging coil is excited at one frequency, preferably at a resonance frequency, and a state in which an excitation is interrupted or no excitation takes place. A particularly simple system design may be achieved as a result of just the two operating states. In addition, a particularly flat efficiency curve over the entire output range may be achieved as a result of just the two operating states.

It is further provided that a period duration of the operating period is at least 1 ms. Preferably, the duration of the operating period is at least 5 ms. Preferably, the duration of the operating period is at least 10 ms. Particularly preferably, the pulse width modulation takes place at a frequency which is significantly lower than a resonance frequency. “Significantly lower” in this case is intended to mean, in particular, at least 100 times, preferably at least 500 times, and particularly preferably at least 1,000 times lower. In this way, a reaction time of the control unit and/or regulating unit may be advantageously held to a minimum, as a result of which, in turn, costs of the control unit and/or regulating unit may be held to a minimum. In addition, a large difference between the frequency of the pulse width modulation and the resonance frequency may make it is possible to advantageously finely adjust a duty cycle. In this way, it is in turn possible to control or transmit also particularly small amounts of energy.

It is further provided that a minimum pulse duration of the pulse width modulation of the control unit and/or regulating unit lies below a value of the transient duration. A “minimal pulse duration” in this context is intended to mean, in particular, a shortest duration of the first operating state switchable by the control unit and/or regulating unit during the pulse width modulation. In addition, a “transient duration” in this context is intended to mean, in particular, a duration which a circuit, in particular an oscillating circuit, requires when excited with a resonance frequency, until a settled state is set. A burst mode in particular may be implemented in this way. Preferably, a standby mode in particular may be implemented in this way, in which a power consumption may be kept advantageously low. In addition, a receiver side and/or an auxiliary voltage source may be supplied with advantageously low energy as a result.

In addition, it is provided that the at least one frequency unit forms at least one part of a half bridge. An advantageous induction charging device, in particular, may be provided in this way. In particular, standard components and standard circuitry for the induction charging device may be utilized as a result.

It is further provided that the at least one frequency unit includes at least two semiconductor switches. Preferably, the frequency unit includes at least two semiconductor power switches. A “semiconductor switch” in this context is intended to mean, in particular, a switching element which is formed by a semiconductor component. Various semiconductor switches are conceivable which appear useful to those skilled in the art, such as in particular IGBTs and/or particularly preferably MOSFETs. A “switching element” in this case is intended to mean, in particular, an electrical component which includes at least two control contacts and at least two power contacts, one of the control contacts and one of the power contacts advantageously being internally at least conductively connected to one another, preferably, short circuited, and the switching element being provided to set a conductivity between the power contacts as a function of an electric signal between the control contacts. In this way, a particularly advantageous frequency unit may be provided. In particular, an advantageous, rapidly switchable frequency unit may be provided in this way. In this way, wear may also be kept to a minimum. In addition, particularly high currents may be switched as a result.

It is further provided that the at least one control unit and/or regulating unit includes at least one interface which is provided for receiving information during a charging operation about a charge state and/or a power requirement of an object to be charged. An “interface” in this context is intended to mean, in particular, a unit which is provided for exchanging data. In particular, the interface includes at least one information input and at least one information output. Preferably the interface includes at least two information inputs and at least two information outputs, in each case at least one information input and at least one information output being provided for connection to a physical system. Particularly preferably, it is intended to mean an interface between at least two physical systems such as, in particular, between the induction charging device and at least one object to be charged such as, in particular, a rechargeable battery. Various interfaces are conceivable which appear useful to those skilled in the art. In particular, however, an interface is intended to mean a wireless interface such as a Bluetooth interface, a WLAN interface, a UMTS interface, a NFC interface and/or particularly preferably an interface for receiving and/or for generating a return channel. Alternatively or in addition, it is intended to mean, in particular, an interface which is implemented at least partially by a charging coil and receiving coil. In this configuration, data may be transmitted, in particular, using a load modulation on a secondary side. Preferably, the charging and receiving coil is formed from the charging coil. In this way, a power output controlled by the control unit and/or regulating unit may be advantageously adapted to an object to be charged.

It is further provided that the at least one control unit and/or regulating unit is provided for adapting a duty cycle of the pulse width modulation to a charge state and/or a power requirement of an object to be charged. In this way, particularly advantageously, a power output controlled or regulated by the control unit and/or regulating unit may be advantageously adapted to an object to be charged. In addition, a particularly advantageous adaptation may be achieved in this way. With an appropriate adaptation, an amplitude of a voltage may also remain unchanged. An amount of energy to be transmitted may, in this case, be controlled and/or regulated via a change of a duration of the first operating state relative to the operating period.

The induction charging device according to the present invention is not intended to be limited to the application and specific embodiment described above. In particular, the induction charging device according to the present invention may include a number which differs from a number of individual elements, components and units mentioned herein for implementing the functionality described herein.

### BRIEF DESCRIPTION OF THE DRAWINGS

FIG. 1 shows a schematic representation of an induction charging device according to the present invention which includes a charging electronics unit, including a control and regulating unit, and an object to be charged.

FIG. 2 shows a circuit diagram of the charging electronics unit of the inductive charging device according to the present invention and of the object to be charged.

FIG. 3 shows a time bar consisting of successive operating periods, each including one first operating state and one second operating state of the charging electronics unit of the induction charging device according to the present invention.

FIG. 4 shows in a schematic diagram in a first control example, a time characteristic of a control voltage of a frequency unit of the charging electronics unit of the induction charging device according to the present invention, and a time characteristic of a voltage of a charging coil of the charging electronics unit of the induction charging device according to the present invention.

FIG. 5 shows in a schematic diagram in a second control example, a time characteristic of the control voltage of the frequency unit of the charging electronics unit of the induction charging device according to the present invention, and a time characteristic of the voltage of the charging coil of the charging electronics unit of the induction charging device according to the present invention.

FIG. 6 shows in a schematic diagram in a third control example, a time characteristic of the control voltage of the frequency unit of the charging electronics unit of the induction charging device according to the present invention, and a time characteristic of the voltage of the charging coil of the charging electronics unit of the induction charging device according to the present invention.

FIG. 7 shows in a schematic diagram in a fourth control example, a time characteristic of the control voltage of the frequency unit of the charging electronics unit of the induction charging device according to the present invention, and a time characteristic of the voltage of the charging coil of the charging electronics unit of the induction charging device according to the present invention.

### DETAILED DESCRIPTION OF THE INVENTION

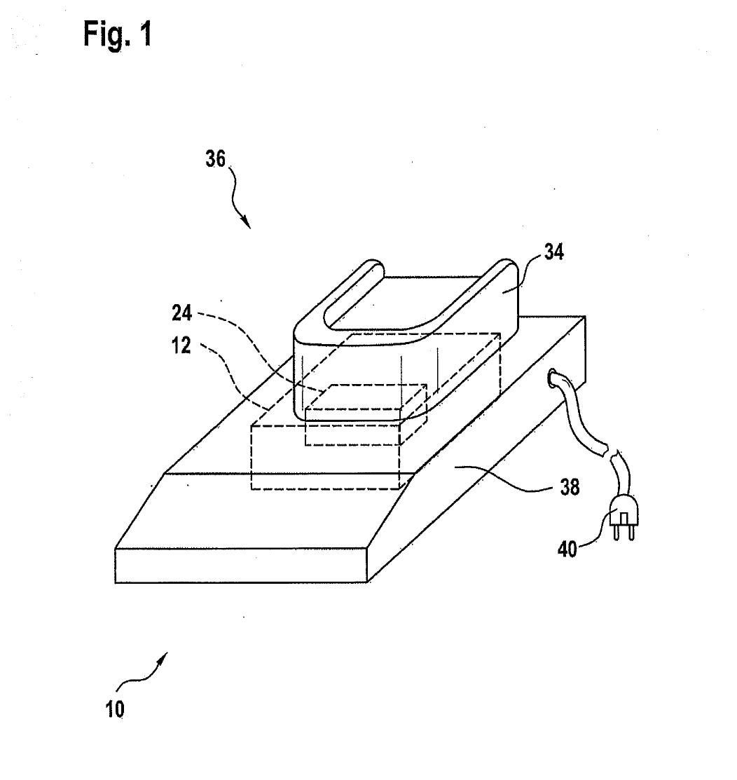

FIG. 1 shows an induction charging device 10 according to the present invention and an object 34 to be charged.

Induction charging device 10 is formed from a primary induction charging device. Consequently, induction charging device 10 forms the primary side of a charging system 36. In addition, induction charging device 10 is formed from a hand-held tool induction charging device. Induction charging device 10 is provided to charge rechargeable batteries of hand tools or hand-held power tools with integrated rechargeable batteries. Object 34 to be charged is formed from a hand tool rechargeable battery. In principle, however, it would also be conceivable to charge other rechargeable batteries appearing useful to those skilled in the art using induction charging device 10. FIG. 1 shows induction charging device 10 and object 34 to be charged in a charging operation. In this case, object 34 to be charged is mounted on an upper side of a housing 38 of induction charging device 10 and is wirelessly charged via a charging coil 22 of induction charging device 10.

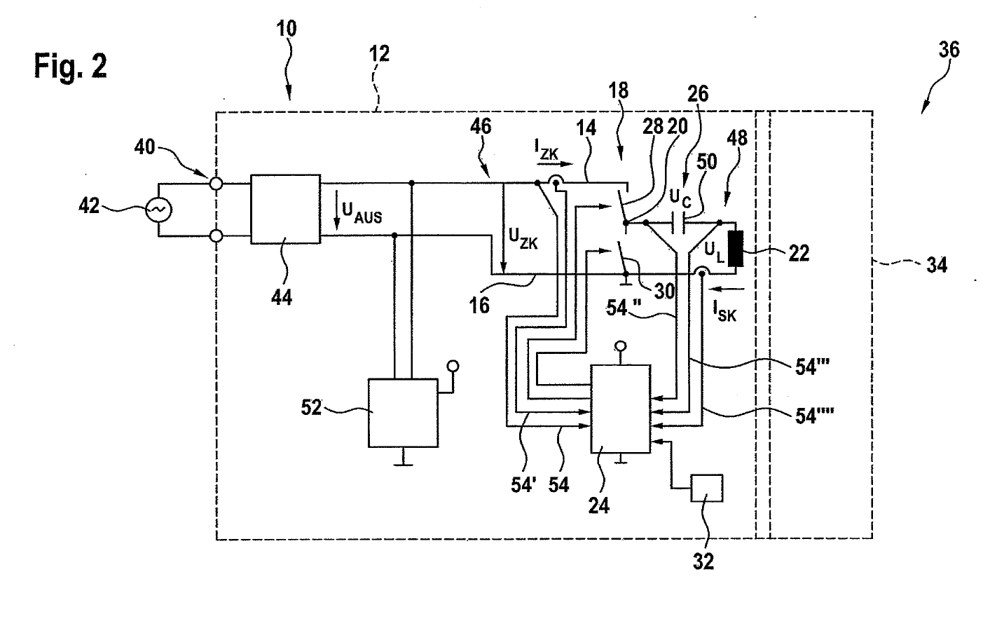

Induction charging device 10 includes a charging electronics unit 12. Charging electronics unit 12 includes a terminal 40 for connecting an AC voltage source 42. Terminal 40 is formed from a plug connector of induction charging device 10. Terminal 40 is connected directly to a rectifier 44, which converts an AC voltage of AC voltage source 42 to a DC voltage. An output voltage U_{OUT} is present at an output side of rectifier 44. Connected to an output side of rectifier 44 is an intermediate circuit 46. Present in intermediate circuit 46 is an intermediate circuit voltage U_{IC}. Intermediate circuit voltage U_{IC} corresponds to DC voltage U_{IN}. In addition, charging electronics unit 12 includes a frequency unit 18 situated between at least two DC current paths 14, 16. DC current paths 14, 16 form a part of intermediate circuit 46. Frequency unit 18 includes two semiconductor switches 28, 30 and one voltage tap 20 situated between semiconductor switches 28, 30. Charging electronics unit 12 also includes charging coil 22 connected to voltage tap 20 of frequency unit 18. Charging coil 22 forms a part of an oscillating circuit 48. Oscillating circuit 48 includes charging coil 22 and a capacitor 50. Oscillating circuit 48 is connected in parallel to a semiconductor switch 30 of semiconductor switches 28, 30 of frequency unit 18. Frequency unit 18 forms a part of a half bridge 26. Frequency unit 18 and oscillating circuit 48 form half bridge 26. Half bridge 26 is situated between DC current paths 14,16 of intermediate circuit 46. Half bridge 26 closes intermediate circuit 46 (FIG. 2).

Charging electronics unit 12 also includes a control unit and regulating unit 24. In principal, control unit and regulating unit 24 may also be designed as merely a control unit or a regulating unit. Control unit and regulating unit 24 is provided for controlling and switching semiconductor switch 28, 30 of frequency unit 18. Control unit and regulating unit 24 is supplied with energy from an auxiliary power supply 52 not otherwise visible. Auxiliary power supply 52 is connected in parallel to intermediate circuit 46. Alternatively or in addition, it would be conceivable for a DC/DC converter to be connected between intermediate circuit 46 and auxiliary power supply 52, which converts intermediate circuit voltage U_{IC} or DC voltage U_{IN} for auxiliary power supply 52 downward in order to adapt it to a request of control unit and regulating unit 24. Control unit and regulating unit 24 also includes multiple information inputs 54, 54′, 54″, 54′″, 54″″, via which control unit and regulating unit 24 receives information regarding an evaluation for a control. Control unit and regulating unit 24 includes one first information input 54, via which intermediate circuit voltage U_{IC} is ascertained. Control unit and regulating unit 24 also includes one second information input 54′, via which an intermediate circuit current I_{IC} is ascertained. In addition, control unit and regulating unit 24 includes one third information input 54″, via which a capacitor voltage U_{c} of capacitor 50 is ascertained. Control unit and regulating unit 24 also includes one fourth information input 54′″, via which a charging coil voltage U_{L} of charging coil 22 is ascertained. In addition, control unit and regulating unit 24 includes a fifth information input 54″″, via which an oscillating circuit current I_{OC} of oscillating circuit 48 is ascertained. In addition, control unit and/or regulating unit 24 includes an interface 32, which is provided for receiving during a charging operation information on a charge state and a power requirement of object 34 to be charged. Interface 32 is formed from a NFC interface. In principle, however, other embodiments of interface 32 which appear useful to those skilled in the art are also conceivable (FIG. 2).

Control unit and regulating unit 24 is provided in a first operating state b₁ for operating frequency unit 18 at one frequency. Control unit and regulating unit 24 is provided for actuating frequency unit 18 to generate a frequency in oscillating circuit 48. Control unit and regulating unit 24 is provided for actuating frequency unit 18 to generate a resonance frequency in oscillating circuit 48. For this purpose, control unit and regulating unit 24 actuates two semiconductor switches 28, 30 of frequency unit 18. In addition, control unit and regulating unit 24 ascertains a resonance frequency at regular intervals in order to operate frequency unit 18 in one resonance frequency. Frequency unit 18 is used as an inverter and converts the rectified intermediate circuit voltage U_{IC} to an AC voltage for oscillating circuit 48. Oscillating circuit 48 is caused by the AC voltage to oscillate in resonance frequency. If oscillating circuit 48 oscillates, charging coil 22 generates a magnetic alternating field which is used for transmitting energy to object 34 to be charged (FIG. 2).

Control unit and/or regulating unit 24 is further provided for regulating a power output via a pulse width modulation of a pulse duration t_{b1} of first operating state b₁ relative to an operating period p. Control unit and/or regulating unit 24 is provided for regulating a power output of charging coil 22 to object 34 to be charged via a pulse width modulation of pulse duration t_{b1} of first operating state b₁ relative to constant operating period p. In this case, operating period p is constant over time. A period duration T of operating period p remains unchanged and is not modulated via the pulse width modulation. Period duration T of operating period p is 10 ms. In principle, however, a different period duration T would also be conceivable. In particular, it is particularly advantageous, however, if period duration T of operating period p is at least 100 times, preferably at least 500 times greater than a period time of the resonance frequency, in particular, a maximum possible resonance frequency during a regular operation. Operating period p consists of pulse-forming, first operating state b₁ and a second operating state b₂ formed from a zero voltage operating state. Operating period p includes first operating state b₁ and second operating state b₂ which follows first operating state b₁. Pulse duration t_{b1} of first operating state b₁ and a duration t_{b2} of second operating state together result in period duration T of operating period p. Multiple operating periods p follow in succession during an operation. During an operation, operating periods p may be continually modulated. During an operating period p, a ratio is modulated between first operating state b₁ and second operating state b₂ via the pulse width modulation of control unit and regulating unit 24. Second operating state b₂ is formed from a zero voltage operating state, i.e., an operating state in which no voltage is transmitted to oscillating circuit 48. In second operating state b₂, both semiconductor switches 28, 30 are opened. In principle, however, it would be conceivable for semiconductor switch 28 to be opened in second operating state b₂ and semiconductor switch 30 to be closed.

Via the pulse width modulation, it is possible to generate different ratios between first operating state b₁ and second operating state b₂. In this case, a minimal pulse duration t_{b1} of the pulse width modulation of control unit and regulating unit 24 lies below a value of the transient duration. In this case, a minimal pulse duration t_{b1} of pulse width modulation of control unit and regulating unit 24 lies below a value of the transient duration of oscillating circuit 48. The transient duration of oscillating circuit 48 is approximately ten periods of the resonance frequency. In principle, however, a different transient duration which appears useful to those skilled in the art would also be conceivable. In this case, a transient duration of approximately ten periods is intended, in particular, to be understood as illustrative. The minimal pulse duration t_{b2} may be as low as one period of the resonance frequency.

Control unit and regulating unit 24 is provided to adapt a duty cycle of the pulse width modulation to a charge state and to a power requirement of object 34 to be charged. Control unit and regulating unit 24 is provided to adapt a duty cycle between pulse-forming first operating state b₂ and operating period p to a charge state and to a power requirement of object 34 to be charged. During a charging operation, interface 32 of control unit and regulating unit 24 receives information about a charge state and a power requirement of object 34 to be charged. The information is processed by control unit and regulating unit 24. If a high power requirement exists, a high duty cycle is set. If a low power requirement exists, such as, for example, in a stand-by mode, or object 34 to be charged is fully charged, a low duty cycle is set.

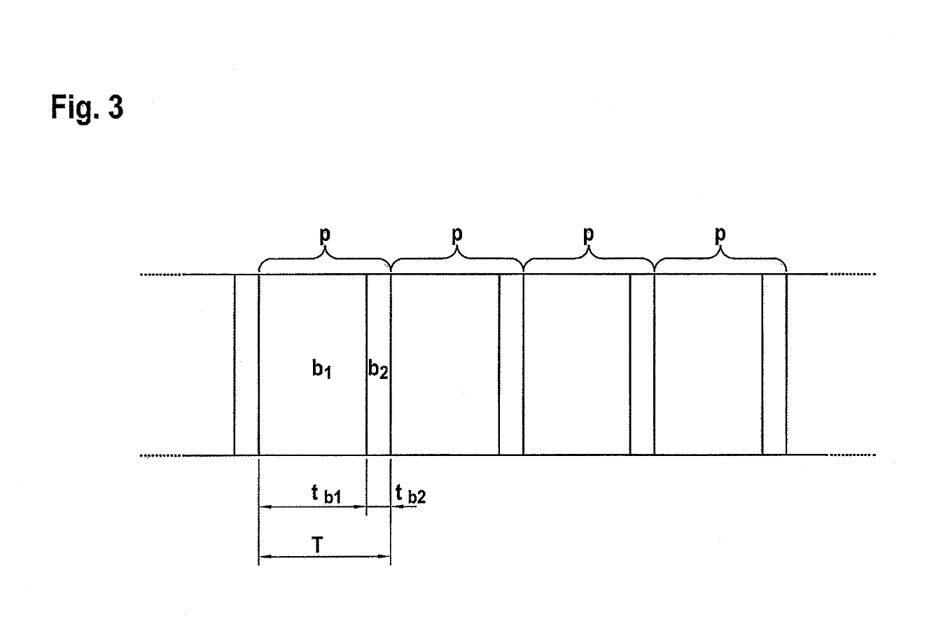

FIG. 3 shows a time bar including multiple successive operating periods p, each including first operating state b₁ and second operating state b₂. FIG. 3 in this case shows in which chronological sequence frequency unit 18 is controlled with which operating state of control unit and regulating unit 24. FIG. 3 shows operating period p with an exemplary duty cycle. In this case, operating periods p follow in continuous succession without interruption during an operation. A control or regulation occurs only via a change in the duty cycle for all subsequent operating periods p.

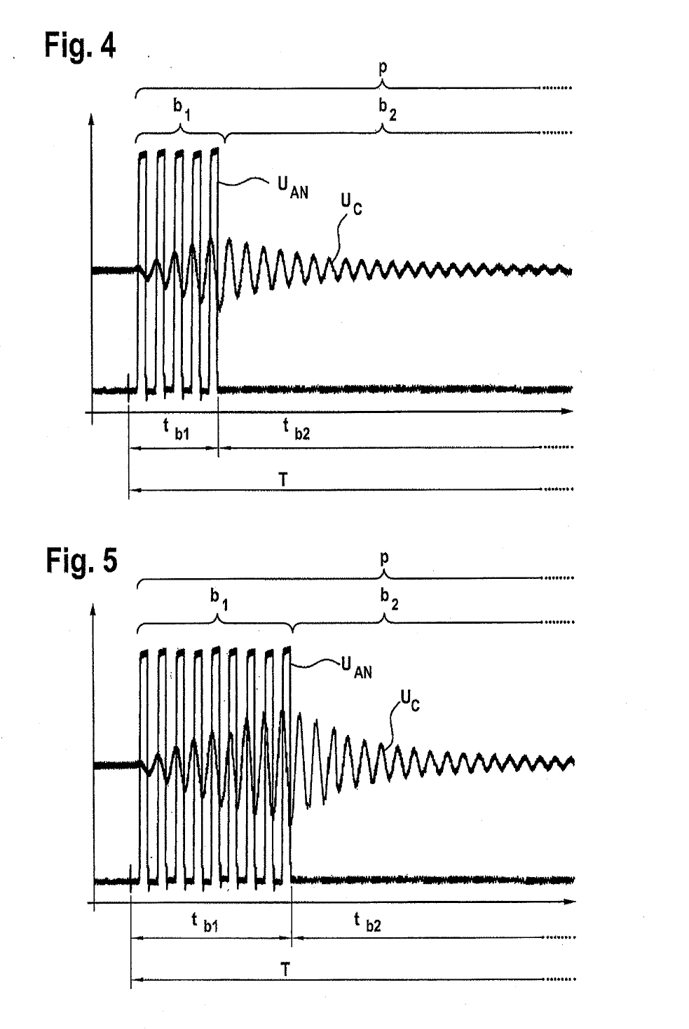

FIGS. 4 through 7 each show a diagram of a time characteristic of an excitation voltage U_{AN} of oscillating circuit 48 and a resulting capacitor voltage U_{c} of oscillating circuit 48. Each of the diagrams in this case shows a portion of operating period p with first operating state b₁ and a portion of second operating state b₂. In each of the diagrams, time is plotted on a x-axis and voltage is plotted on a y-axis.

In the diagram from FIG. 4, first operating state b₁ is maintained over 5 periods of the resonance frequency until followed by second operating state b₂. The resonance frequency in this case is at 100 kHz, for example. This results in a pulse duration t_{b1} of first operating state b₁ per operating period p of 0.05 ms. This, in turn, results in a duty cycle of the pulse width modulation of 0.5%, at a frequency of the pulse width modulation of 100 Hz.

In the diagram from FIG. 5, first operating state b₁ is maintained over 9 periods of the resonance frequency until followed by operating state b₂. The resonance frequency in this case is again at 100 kHz, for example. This results in a pulse duration t_{b1} of first operating state b₁ per operating period p of 0.09 ms. This, in turn, results in a duty cycle of the pulse width modulation of 0.9%, at a frequency of the pulse width modulation of 100 Hz.

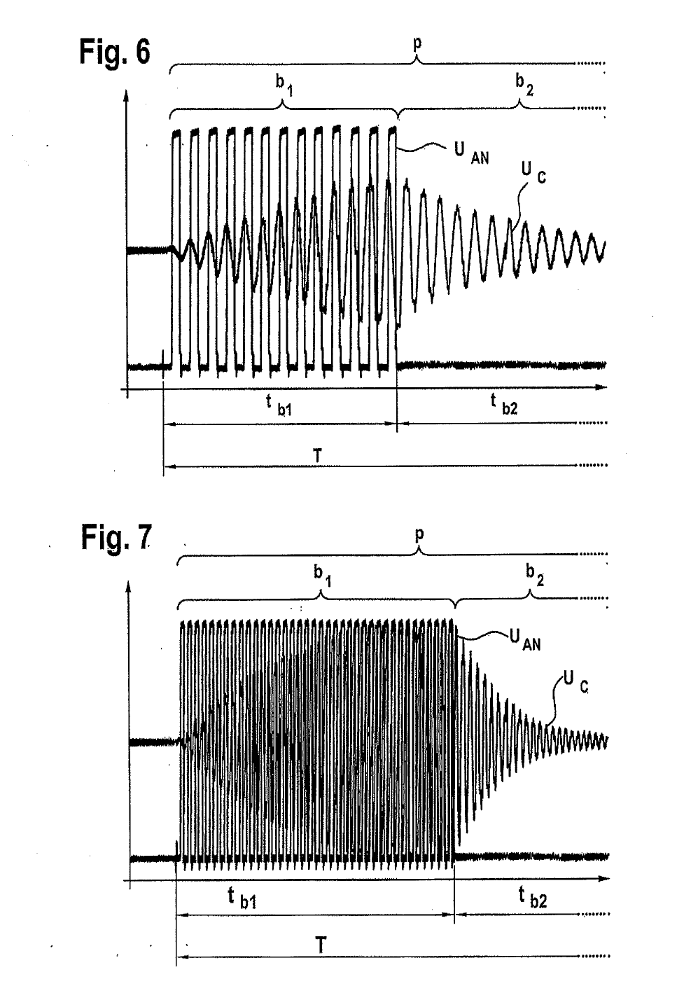

In the diagram from FIG. 6, first operating state b₁ is maintained over 13 periods of the resonance frequency until followed by operating state b₂. The resonance frequency in this case is at 100 kHz, for example. This results in a pulse duration t_{b1} of first operating state b₁ per operating period p of 0.13 ms. This, in turn, results in a duty cycle of the pulse width modulation of 1.3%, at a frequency of the pulse width modulation of 100 Hz.

In the diagram from FIG. 7, first operating state b₁ is maintained over 5 periods of the resonance frequency until followed by operating state b₂. The resonance frequency in this case is at 100 kHz, for example. This results in a pulse duration t_{b1} of first operating state b₁ per operating period p of 0.38 ms. This, in turn, results in a duty cycle of the pulse width modulation of 3.8%, at a frequency of the pulse width modulation of 100 Hz.

What is claimed is:

1. An induction charging device, comprising:
at least one charging electronics unit including:
at least one frequency unit situated between at least two DC voltage paths;
at least one charging coil connected to a voltage tap of the at least one frequency unit; and
at least one control unit configured to operate the at least one frequency unit at one frequency in at least one first operating state, wherein the at least one control unit controls a power output via a pulse width modulation of a pulse duration of the first operating state relative to an operating period.

2. The induction charging device as recited in claim 1, wherein the at least one control unit controls a power output via a pulse width modulation of a pulse duration of the first operating state relative to a constant operating period.

3. The induction charging device as recited in claim 2, wherein the operating period includes the pulse-forming, first operating state and one second operating state formed from a zero voltage operating state.

4. The induction charging device as recited in claim 3, wherein a period duration of the operating period is at least 1 ms.

5. The induction charging device as recited in claim 3, wherein a minimum pulse duration of the pulse width modulation of the control unit is below a value of a transient duration.

6. The induction charging device as recited in claim 3, wherein the at least one frequency unit forms at least a part of a half bridge.

7. The induction charging device as recited in claim 3, wherein the at least one frequency unit includes at least two semiconductor switches.

8. The induction charging device as recited in claim 3, wherein the at least one control unit includes at least one interface configured to receive during a charging operation information regarding at least one of a charge state and a power requirement of an object to be charged.

9. The induction charging device as recited in claim 3, wherein the at least one control unit adapts a duty cycle of the pulse width modulation to at least one of a charge state and a power requirement of an object to be charged.

10. A method for controlling a power output of an induction charging device having at least one frequency unit situated between at least two DC voltage paths, at least one charging coil connected to a voltage tap of the at least one frequency unit, and at least one control unit, the method comprising:
operating, by the at least one control unit, the at least one frequency unit at one frequency in at least one first operating state, wherein the at least one control unit controls a power output via a pulse width modulation of a pulse duration of the first operating state relative to an operating period.
